(19) United States
(12) Patent Application Publication
(10) Pub. No.: US 2018/0334585 A1
(43) Pub. Date: Nov. 22, 2018

(54) PRETREATMENT FOR SOLVENT CEMENTS

(71) Applicant: IPS Corporation, Compton, CA (US)

(72) Inventors: Young Wu, Diamond Bar, CA (US); Andreas Schneider, Fullerton, CA (US)

(21) Appl. No.: 15/982,581

(22) Filed: May 17, 2018

Related U.S. Application Data
(60) Provisional application No. 62/509,268, filed on May 22, 2017.

(51) Int. Cl. C09D 139/02; C09D 179/02; C09J 127/24

(52) U.S. Cl. CPC C09D 139/02; C09J 127/24; C09D 179/02

(57) ABSTRACT

Provided herein are pretreatments that can be used in solvent cementing, including pretreatment compositions comprising a polyamine. Also provided are methods of using pretreatment compositions, including for use in preparing a surface for solvent cement bonding.

### RELATED APPLICATION

This application claims the benefit of U.S. Provisional Application Ser. No. 62/509,268, filed May 22, 2017, the disclosure of which is incorporated herein by reference in its entirety.

### FIELD

This invention generally relates to pretreatments used in solvent cementing, including pretreatment compositions comprising a polyamine, and methods of using the same, including for use in preparing a surface for solvent cement bonding.

### BACKGROUND

Certain thermoplastic materials such as polyvinyl chloride (PVC) are widely used in the building industry because of their relative hardness and strength. In particular, PVC is used to make pipes, e.g. in industrial pressure systems, sewage or protecting electrical wiring, as well as for drinking water systems. Such pipes are often based on, or made from, specific types of PVC including PVC and chlorinated PVC (CPVC).

PVC resins in which no plasticizers have been added are designated as a hard plastic. Such a PVC is able to resist temperatures up to about 60° C. CPVC is a chlorinated PVC which is obtained by chlorination of PVC. CPVC has an increased hardness due to the chlorination as well as an increased temperature resistance (up to about 95° C.). CPVC can be used as construction material for cold and hot water pipes.

The difference between PVC and CPVC can be expressed in terms of the percentage by mass of chlorine (or chloride atoms), which is present in both types of PVC. Usually, PVC contains about 57 wt. % of chlorine, while the chlorine percentage of CPVC is typically above this value. The exact value for CPVC is dependent on the degree of chlorination which has been applied.

Solvent cements function by welding thermoplastic sheets and/or piping by softening the surface of the material being bonded. Unlike gluing, which hardens to hold material together, the polymer chains of the softened material intermingle to form a solvent-welded joint that has the strength of the parent material. Proper preparation and primers allow the solvent to form a bond without contamination from grease, inks and oils.

A solvent cement for bonding articles made of a thermoplastic resin is usually a solution of polymers of the same or a different thermoplastic resin in a suitable solvent or solvent mix. Most commonly, the solvent mix used in a PVC-based or CPVC solvent cement contains tetrahydrofuran (THF) due to its ability to dissolve PVC or CPVC. Other aggressive and harmful solvents that may be used in solvent cements for thermoplastic resins include N-Methyl-2-pyrrolidone (NMP), dimethyl sulfoxide (DMSO), dimethyl formamide (DMF), and/or others.

When bonding an article made of a thermoplastic resin such as PVC or CPVC, the solvent cement is applied onto the surfaces to be bonded. The solvent in the cement solvates the PVC molecules on the surface of the substrate. Depending on time and temperature, the adhesive dries at a different rate by diffusion of the solvent through the PVC and/or by evaporation of the solvent in air. After drying, a joint formed by the adhesive is obtained with smoothly bonded surfaces. In this context, it can be referred to as a fusion, or solvent welding, of the two surfaces by means of an adhesive.

The use of potentially hazardous and volatile substances such as THF or others as mentioned above as solvents for such solvent cements has, however, major disadvantages, because of the health hazard concerns. For example, new European regulations came into force that classify THF as a suspected carcinogen (cf. 3rd Adaptation to Technical Progress (ATP) to the EU Classification, Labeling and Packaging Regulation EC No. 1272/2008 (CLP)). At present, a new regulation is already in force in France that bans the use of solvent cements comprising harmful solvents for drinking water applications.

Primers can be used in the solvent cement process to prepare plastics pipes, fittings, surfaces and other articles or objects for solvent cementing or solvent bonding by cleaning and softening the object to increase adhesion once a solvent based adhesive is subsequently applied. The pipes, fittings or other subjects being bonded are typically prepared from PVC (polyvinyl chloride), CPVC (chlorinated polyvinyl chloride), ABS (acrylonitrile-butadiene-styrene) and other thermoplastics or polymers. Before applying a solvent cement, the surfaces to be joined are normally treated with a primer containing a solvent capable of at least partially dissolving or softening the surface to be bonded.

Primers for solvent cementing have to be applied shortly before the application of the solvent cement in a wet in wet fashion. This can be difficult to achieve on warm days or for larger pipes and fittings.

Primers increase the amount of solvent that diffuses into the object and therefore increase the cure time required before a piping system can be pressurized and placed into service.

Additionally, primers contain substantial amounts of unpleasant or harmful solvent such as cyclohexanone and tetrahydrofuran. Further, conventional primers are usually low viscosity solutions, typically having a viscosity below the viscosity of water. These low viscosity primers are prone to dripping, spilling, and otherwise separating from the surface of the object to be bonded.

### SUMMARY

One aspect of the present invention is directed to a pretreatment composition comprising: at least one polyamine in an amount in a range of about 0.1% to about 10% by weight of the pretreatment composition; and a solvent comprising an organic solvent and/or water.

Another aspect of the present invention is directed to a substrate comprising a thermoplastic resin and a coating on at least a portion of a surface of the thermoplastic resin, wherein the coating comprises a pretreatment composition as described herein.

A further aspect of the present invention is directed to a method comprising: applying a pretreatment composition as described herein to a first surface of a first thermoplastic resin, wherein the first thermoplastic resin is a polyvinyl chloride (PVC) resin, chlorinated PVC (CPVC) resin, and/or acrylonitrile-butadiene-styrene (ABS) resin.

An additional aspect of the present invention is directed to a system comprising: a pretreatment composition as described herein; and a solvent cement comprising a thermoplastic resin and a second solvent.

A further aspect of the present invention is directed to an article comprising: a first substrate and a second substrate, wherein the first and second substrate are joined together using a solvent-welded joint, wherein the solvent-welded joint is formed using the pretreatment composition as described herein and/or a method as described herein.

Another aspect of the present invention is directed to a pretreatment composition as described herein; and a solvent cement comprising a thermoplastic resin and a second solvent.

Disclosed herein are example embodiments of a pretreatment composition that can be easy to apply, can replace the function of a cleaner and/or a primer, and/or results in bonded pipe and fittings with similar or improved performance compared to conventional pretreatments and/or primers.

In some embodiments, a pretreatment composition for use in preparing a thermoplastic or other polymer-based surface for solvent cement bonding is provided. The pretreatment composition contains at least one polyamine dissolved in an organic solvent or dispersed in water. The pretreatment composition comprises a polyamine in a range from about 0.1% to about 10% by weight relative to the weight of the entire composition. The polyamine may comprise polyethyleneimine, polyallylamine, polyvinylamine or other oligomers and polymers containing multiple amine groups.

In some embodiments, the pretreatment comprises, consists essentially of, or consists of a polyamine and a solvent that is capable of dissolving the polyamine. Some embodiments include a solvent that is a ketone such as methyl ethyl ketone and/or acetone; ether such as dioxolane; and/or alcohol such as isopropanol and/or ethanol.

In some embodiments, the pretreatment composition comprises, consists essentially of, or consists of a polyamine, a surfactant, and water.

Some embodiments are directed to a process for preparing a surface for solvent cement bonding. The process comprises applying a pretreatment composition as described herein and drying of the pretreatment composition (e.g., the solvents or water in the pretreatment). The pretreatment composition contains at least one polyamine dissolved in an organic solvent or dispersed in water. The pretreatment composition comprises a polyamine in a range from about 0.1% to about 10% by weight relative to the weight of the entire composition. The polyamine may comprise polyethyleneimine, polyallylamine, polyvinylamine or other oligomers and polymers containing multiple amine groups.

In some embodiments, the disclosure is directed to a pretreatment/solvent cement system for use in bonding a plastic object to another object. The pretreatment/solvent cement system comprises a pretreatment composition and a solvent cement. The pretreatment composition contains at least one polyamine dissolved in an organic solvent or dispersed in water. The pretreatment composition comprises a polyamine in a range from about 0.1% to about 10% by weight relative to the weight of the entire composition. The polyamine may comprise polyethyleneimine, polyallylamine, polyvinylamine or other oligomers and polymers containing multiple amine groups. The solvent cement contains a thermoplastic resin dissolved in a second solvent. In some embodiments, the solvent cement is separate from the pretreatment composition, e.g., packaged and/or stored separately.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### DETAILED DESCRIPTION

The present invention may be understood more readily by reference to the following description taken in connection with the accompanying Figures and Examples, all of which form a part of this disclosure. It is to be understood that this invention is not limited to the specific products, methods, conditions or parameters described or shown herein, and that the terminology used herein is for the purpose of describing particular embodiments by way of example only and is not intended to be limiting of the invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer to compositions and methods of making and using said compositions. That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using).

As used in the description of the invention and the appended claims, the singular forms “a,” “an,” and “the” include the plural forms as well, unless the context clearly indicates otherwise. Thus, for example, a reference to “a material” is a reference to one or more of such materials and equivalents thereof known to those skilled in the art, and so forth.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety. In case of a conflict in terminology, the present specification is controlling.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the transitional phrase “consisting essentially of” (and grammatical variants) is to be interpreted as encompassing the recited materials or steps “and those that do not materially affect the basic and novel characteristic(s)” of the claimed invention. See, In re Herz, 537 F.2d 549, 551-52, 190 U.S.P.Q. 461, 463 (CCPA 1976) (emphasis in the original); see also MPEP § 2111.03. Thus, the term “consisting essentially of” as used herein should not be interpreted as equivalent to “comprising.”

The term “about,” as used herein when referring to a measurable value such as an amount or concentration and the like, is meant to encompass variations of ±10%, ±5%, ±1%, 0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measureable value may include any other range and/or individual value therein.

As used herein, the terms “increase,” “increases,” “increased,” “increasing”, “improve”, “enhance”, and similar terms indicate an elevation in the specified parameter of at least about 5%, 10%, 15%, 20%, 25%, 30%, 35%, 40%, 45%, 50%, 55%, 60%, 65%, 70%, 75%, 80%, 85%, 90%, 95%, 100%, 150%, 200%, 300%, 400%, 500% or more.

As used herein, the terms “reduce,” “reduces,” “reduced,” “reduction”, “inhibit”, and similar terms refer to a decrease in the specified parameter of at least about 5%, 10%, 15%, 20%, 25%, 30%, 35%, 40%, 45%, 50%, 55%, 60%, 65%, 70%, 75%, 80%, 85%, 90%, 95%, 97%, or 100%.

Several illustrative embodiments will be described in detail with the understanding that the present disclosure merely exemplifies the general inventive concepts. While embodiments encompassing the general inventive concepts may take various forms, the general inventive concepts are not intended to be limited to the specific embodiments described herein.

According to embodiments of the present invention, adhesively bonded pipes, fittings, articles, objects, or surfaces described herein may comprise PVC (polyvinyl chloride), CPVC (chlorinated polyvinyl chloride), and/or ABS (acrylonitrile butadiene styrene) plastics. In this context, it will be understood that polymers comprising “PVC,” “CPVC,” “ABS” and similar designations refer to polymers which can include other monomers in addition to the vinyl chloride, acrylonitrile, butadiene and/or styrene monomers being specifically referred to.

Similarly, “polymer” in the context of this disclosure will be understood to include homopolymers, copolymers, terpolymers, etc. In addition to PVC, CPVC and ABS, embodiments of the present invention may be applicable to bonding all other types of plastics capable of being adhesively bonded with solvent cements. Examples include, but are not limited to, HIPS (high impact polystyrene), SAN (styrene acrylonitrile), acrylics and/or polyamides. As known in the art, adhesively bonded pipes, fittings, articles, objects, or surfaces described herein may additionally comprise one or more ingredients such as, but not limited to, a filler, impact modifier, extrusion-molding aid, injection-molding aid, and/or stabilizer.

Provided according to embodiments of the present invention are pretreatment compositions. A pretreatment composition of the present invention comprises at least one polyamine in an amount in a range of about 0.1% to about 10% by weight of the pretreatment composition; and a solvent comprising an organic solvent and/or water. In some embodiments, the at least one polyamine may be present in an amount of about 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, or 10% by weight of the pretreatment composition.

The polyamine may comprise polyethyleneimine, polyallylamine, polyvinylamine, or other oligomers and polymers containing multiple amine groups. Example polyethyleneimines include, but are not limited to, branched spherical polymeric amines, such as, e.g., those available from BASF Corp. under the tradename LUPASOL®; water soluble partly branched polymers containing primary, secondary, and/or tertiary amines such as, e.g., those available from NIPPON SHOKUBAI CO., LTD. under the tradename EPOMIN®; and/or aminoethylated acrylic polymers such as, e.g., those available from NIPPON SHOKUBAI CO., LTD. under the tradename POLYMENT®. Example polyvinylamines include, but are not limited to, those are available from Applied Chemicals International AG under the tradename BONDSTAR®.

Example polyallylamines include, but are not limited to, polyallylamines in aqueous solutions, such as, e.g., those available from Sigma-Aldrich in various molecular weights. In some embodiments, the pretreatment composition comprises a polyethyleneimine, polyallylamine, and/or polyvinylamine.

A pretreatment composition of the present invention may include a solvent, such as, e.g., an organic solvent and/or water. In some embodiments, the pretreatment composition may comprise an organic solvent and water. In some embodiments, the polyamine is dissolved in an organic solvent. Example organic solvents include, but are not limited, alcohols such as, e.g., isopropanol and/or ethanol; ketones such as, e.g., acetone and/or methyl ethyl ketone; esters such as, e.g., ethylactetate; and/or aromatic solvents such as, e.g., toluol and/or xylol. An organic solvent may be used alone as the solvent for the composition, or may be used in combination with water and/or one or more (e.g., 2, 3, 4, or more) organic solvents that are used together and considered as the solvent for the composition. In some embodiments, the pretreatment composition comprises two or more (e.g., 2, 3, 4, or more) organic solvents. In some embodiments, the organic solvent is methyl ethyl ketone (MEK). In some embodiments, the organic solvent for the polyamine is a combination of methyl ethyl ketone (MEK) and acetone. Suitable organic solvent(s) may be different depending on the thermoplastic resin employed. Appropriate solvents may be chosen for the respective thermoplastic (e.g., thermoplastic piping system) used, as will be apparent to persons skilled in the art. In some embodiments, the solvent is water. In some embodiments, the polyamine is dispersed in water.

A solvent (e.g., an organic solvent and/or water) may be present in a pretreatment composition of the present invention in an amount of at least about 90% or more by weight of the pretreatment composition. In some embodiments, the solvent may be present in a pretreatment composition in an amount of about 90%, 91%, 92%, 93%, 94%, 95%, 96%, 97%, 98%, 99%, or more.

The pretreatment composition of the present invention may have a neutral or basic pH. In some embodiments, the pretreatment composition has a pH in a range of about 7 to about 9. In some embodiments, the pretreatment composition has a pH of about 7, 7.5, 8, 8.5, 9, or more.

The polyamine may have a molecular weight in a range of about 500 to about 2,500,000 g/mol. In some embodiments, the polyamine has a molecular weight of about 500, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 500,000, 1,000,000, 1,500,000, 2,000,000, or 2,500,000 g/mol. In some embodiments, the polyamine (e.g., polyethyleneimine and/or polyethyleneimine) has a molecular weight in a range of about 500 or 1,000 to about 1,500 or 2,000 g/mol.

In some embodiments, the polyamine may have a viscosity in a range of about 250 to about 10,000 mPa·s at 23° C. as measured in accordance with ASTM D1084 Method B. In some embodiments, the polyamine has a viscosity of about 250, 300, 400, 500, 600, 700, 800, 900, 1,000, 2,000, 3,000, 4,000, 5,000, 6,000, 7,000, 8,000, 9,000, or 10,000 mPa·s at 23° C. as measured in accordance with ASTM D1084 Method B.

In some embodiments, water can be used instead of an organic solvent. When water is used as the solvent, the composition may also include a surfactant. A surfactant may be used to provide wetting of the polyamine (e.g., polyethyleneimine) water solution on a substrate. Example surfactants include, but are not limited to, nonionic surfactants, such as, but not limited to alkyl polyethylene glycol ethers, e.g., Lutensol XL 90 and/or Lutensol ON 60 available from BASF Corp. Alternatively or in addition, a water soluble solvent such as, but not limited to, ethanol, can be used to ensure good wetting.

The pH of the water based solution can influence the charge density, and at lower pH values the charge density is much higher leading potentially to better adhesion effects.

In some embodiments, the pretreatment composition has a viscosity of about 6,000 mPa·s or less, such as, e.g., 5,000, 3,000, 1,000, 500, 250, 100, 10, or 1 mPa·s or less at 23° C. as measured in accordance with ASTM D1084 Method B. In some embodiments, the pretreatment composition has a viscosity of about 1, 10, 100, 250, 500, 750, 1,000, 2,000, 3,000, 4,000, 5,000, or 6,000 mPa·s at 23° C. as measured in accordance with ASTM D1084 Method B. In some embodiments, the pretreatment composition has a viscosity below the viscosity of water. In some embodiments, the pretreatment composition has a viscosity of less than about 0.9321 mPa·s at 23° C. as measured in accordance with ASTM D1084 Method B.

A pretreatment composition of the present invention may comprise one or more excipients. Example excipients include, but are not limited to, a masking agent, viscosity increasing agent, and/or colorant. An excipient may be present in an amount of about 10% by weight of the composition or less, such as, e.g., about 9%, 8%, 7%, 6%, 5%, 4%, 3%, 2%, or 1% by weight of the composition or less.

In some embodiments, a pretreatment composition of the present invention is devoid of tetrahydrofuran (THF), N-methyl-2-pyrrolidone (NMP), dimethyl sulfoxide (DMSO), and/or dimethyl formamide (DMF).

A pretreatment composition of the present invention may be compatible and/or used with a solvent cement. In some embodiments, the pretreatment composition may be compatible and/or used with a solvent cement that is devoid of THF, NMP, DMSO, and/or DMF. This may be advantageous as these substances are potentially hazardous substances.

In some embodiments, the pretreatment composition is compatible and/or used with a thermoplastic resin, such as, but not limited to, a polyvinyl chloride (PVC) resin, chlorinated PVC (CPVC) resin, and/or acrylonitrile-butadiene-styrene (ABS) resin. The thermoplastic resin may have a surface that does not have an ionic charge. In some embodiments, a surface of the thermoplastic resin may be polar. The pretreatment composition may at least partially dissolve and/or soften a surface of the thermoplastic resin.

A pretreatment composition of the present invention may at least partially dissolve and/or soften a surface comprising a thermoplastic resin. In some embodiments, the thermoplastic resin is a PVC resin, CPVC resin, and/or ABS resin.

Provided according to embodiments of the present invention is a substrate comprising a thermoplastic resin and a coating on at least a portion of a surface of the thermoplastic resin, wherein the coating comprises a pretreatment composition of the present invention. The coating may be a thin layer on the surface of the thermoplastic resin. In some embodiments, the coating is a monolayer. In some embodiments, the coating is wet. In some embodiments, the coating is dry. “Dry” as used herein can refer to at least a portion of the solvent having evaporated from the pretreatment solution. In some embodiments, a dry coating is provided when a majority the solvent has evaporated from the pretreatment solution. When dry, the coating may not be visible on the surface of the thermoplastic resin. In some embodiments, the coating is a film.

The thermoplastic resin may be a polyvinyl chloride (PVC) resin, chlorinated PVC (CPVC) resin, and/or acrylonitrile-butadiene-styrene (ABS) resin. In some embodiments, the substrate may be a pipe or a pipe joint.

In some embodiments, provided is a method comprising: applying a pretreatment composition of the present invention to a first surface of a first thermoplastic resin. The first thermoplastic resin may be a polyvinyl chloride (PVC) resin, chlorinated PVC (CPVC) resin, and/or acrylonitrile-butadiene-styrene (ABS) resin. Applying the pretreatment composition may comprise applying the pretreatment composition using methods known to those of skill in the art.

In some embodiments, applying the pretreatment composition may comprise applying the pretreatment composition to the first surface using an applicator. Example applicators include, but are not limited to, a paper towel, a fiber or cellulosic cloth, and/or a brush. In some embodiments, the applicator may be a paper towel, such as, but not limited to, a Scott® Multi-Fold towel available from Kimberly-Clark Professional. In some embodiments, the applicator may be a cloth, such as, but not limited to, a nonwoven cloth and/or a Kimberly-Clark Dual-Texture Meltdown scrubby or smooth nonwoven cloth. In some embodiments, a surface of the applicator may have a root mean square roughness in a range of about 10 to about 20 nm as measured in accordance with known techniques, such as, e.g., atomic force microscopy.

In some embodiments, the method may comprise drying the pretreatment composition. Drying the pretreatment composition may comprise evaporating at least a portion of the solvent (e.g., organic solvent and/or water) from the pretreatment composition. Some embodiments include cleaning the first surface prior to applying the pretreatment solution.

In some embodiments, the method may comprise applying a solvent cement onto the first surface including the pretreatment composition. The pretreatment composition may be dry prior to applying the solvent cement onto the first surface. The solvent cement may comprise a thermoplastic resin and a solvent. In some embodiments, the solvent cement is devoid of THF, NMP, DMSO, and/or DMF.

A method of the present invention may comprise contacting a second thermoplastic resin having a second surface to the first surface comprising the pretreatment composition and forming a solvent-welded joint between the first surface and second surface. In some embodiments, the second surface of the second thermoplastic resin may also comprise a pretreatment composition and/or a solvent cement, which may be the same or a different pretreatment composition and/or solvent cement as the first surface. In some embodiments, the second thermoplastic resin is a PVC resin, CPVC resin, and/or ABS resin.

An object, substrate, and/or method of the present invention may not be chemically degraded, such as, e.g. by oxidative degradation. In some embodiments, a surface of an object and/or substrate may be devoid of chemical degradation (e.g., oxidative degradation). In some embodiments, the first surface of the first thermoplastic resin and/or second surface of the second thermoplastic resin may be devoid of chemical degradation (e.g., oxidative degradation). In

A method of the present invention may provide a solvent-welded joint that withstands a pressure of about 17 Bar and temperature of about 80° C. for about 100 hours or more as tested in accordance with EN 14814 and/or ISO 9311-3 with the joint having a diameter of 63 mm. In some embodiments, the solvent-welded joint withstands a pressure of about 17 Bar and temperature of about 80° C. for about 100, 125, 150, 175, 200, 225, 250, 275, 300, 350, 400, 450, 500, 550, 600, 650, 700, 750, 800, 850, 900, 950, 1,000, 1,500, 2,000, 2,500, 3,000, or 3,500 hours as tested in accordance with EN 14814 and/or ISO 9311-3 with the joint having a diameter of 63 mm. In some embodiments, the solvent-welded joint withstands a pressure of about 17 Bar and temperature of about 80° C. for at least about 1,000, 2,000, or 3,000 hours or more as tested in accordance with EN 14814 and/or ISO 9311-3 with the joint having a diameter of 63 mm.

A method of the present invention may provide a solvent-welded joint that has a hydrostatic burst strength of about 27 Bar or more or about 400 PSI or more as tested in accordance with ASTM D2564 6.3.3. In some embodiments, the solvent-welded joint has a hydrostatic burst strength of about 27, 28, 29, 30, 31, 32, 33, 34, 35, 36, 37, 38, 39, 40, 41, 42, 43, 44, 45, 46, 47, 48, 49, 50, 51, 52 Bar or more as tested in accordance with ASTM D2564 6.3.3 or about 400, 450, 500, 550, 600, 650, 700, 750 PSI or more as tested in accordance with ASTM D2564 6.3.3.

Provided according to some embodiments of the present invention is a system comprising a pretreatment composition of the present invention; and a solvent cement as described herein. The solvent cement may comprise a thermoplastic resin and a second solvent, and may be devoid of THF, NMP, DMSO, and/or DMF.

Embodiments of the present invention (e.g., a composition, system, and/or method of the present invention) may provide similar or improved adhesive, temperature resistance, and/or strength properties and/or results in regard to the obtained bond compared to current commercial compositions and/or systems, including systems using solvent cements containing one or more of THF, NMP, DMSO, and/or DMF. Embodiments of the present invention may provide similar or improved properties with respect to workability and/or drying compared to current commercial compositions and/or systems, including systems using solvent cements containing one or more of THF, NMP, DMSO, and/or DMF.

In some embodiments, a pretreatment composition of the present invention is compatible with and/or used for and/or with a solvent cement that does not comprise THF, NMP, DMSO, and/or DMF, and exhibits similar or improved properties compared to current commercial compositions and/or systems that include solvent cements that contain THF, NMP, DMSO, and/or DMF. In some embodiments, a pretreatment composition of the present invention provides improved adhesive, temperature resistance, and/or strength properties and/or results in regard to the obtained bond compared to a current commercial composition and/or system that is not THF-free. In some embodiments, a method, system, composition, and/or article of the present invention provides a bonded article that does not endanger the safety and/or health of the user, and provides advantageous and/or improved bonding properties.

In some embodiments, an article is provided that comprises a first substrate and a second substrate, wherein the first substrate and the second substrate are joined together using a solvent-welded joint. The solvent-welded joint is formed using a pretreatment composition of present invention and/or using a method of the present invention.

The solvent-welded joint of the article may withstand a pressure of about 17 Bar and temperature of about 80° C. for about 100 hours or more as tested in accordance with EN 14814 and/or ISO 9311-3 with a diameter of 63 mm. In some embodiments, the solvent-welded joint withstands a pressure of about 17 Bar and temperature of about 80° C. for about 100, 125, 150, 175, 200, 225, 250, 275, 300, 350, 400, 450, 500, 550, 600, 650, 700, 750, 800, 850, 900, 950, 1,000, 1,500, 2,000, 2,500, 3,000, or 3,500 hours as tested in accordance with EN 14814 and/or ISO 9311-3 with a diameter of 63 mm. In some embodiments, the solvent-welded joint withstands a pressure of about 17 Bar and temperature of about 80° C. for at least about 1,000, 2,000, or 3,000 hours or more as tested in accordance with EN 14814 and/or ISO 9311-3 with a diameter of 63 mm.

In some embodiments, the solvent-welded joint of the article may have a hydrostatic burst strength of about 27 Bar or more or about 400 PSI or more as tested in accordance with ASTM D2564 6.3.3. In some embodiments, the solvent-welded joint may have a hydrostatic burst strength of about 27, 28, 29, 30, 31, 32, 33, 34, 35, 36, 37, 38, 39, 40, 41, 42, 43, 44, 45, 46, 47, 48, 49, 50, 51, 52 Bar or more as tested in accordance with ASTM D2564 6.3.3 or about 400, 450, 500, 550, 600, 650, 700, 750 PSI or more as tested in accordance with ASTM D2564 6.3.3.

Provided according to some embodiments is a kit that comprises a pretreatment composition of the present invention; and a solvent cement comprising a thermoplastic resin and a second solvent. The pretreatment composition and/or solvent cement may be devoid of THF, NMP, DMSO, and/or DMF. In some embodiments, the pretreatment composition and solvent cement in the kit are separately stored.

The present invention is explained in greater detail in the following non-limiting examples.

### EXAMPLES

### Example 1

Preparation of Pretreatment Compositions:

An amine based adhesion promoter was dissolved or dispersed in an organic solvent or water using a high shear mixer. When an organic solvent was used, the adhesion promoter was dissolved in the organic solvent.

Preparation of a Solvent Cement for Pressure Testing:

CPVC resin was dissolved in MEK and 1,3-dioxolane as provided in Table 1. Once the resin was completely dissolved fumed silicon dioxide was added to increase the viscosity using a high shear mixer.

TABLE 1
Solvent Cement Composition.

| | | Percentage |
|---|---|---|
| Components | CAS Number | (w/w) |
| Methyl Ethyl Ketone (MEK) | 78-93-3 | 42 |
| 1,3-Dioxolane | 646-06-0 | 42 |
| Sekisui HA-24KL | 68648-82-8 | 13.83 |
| Silicon Dioxide | 112945-52-5 | 2.17 |

Joints for pressure testing were prepared and conditioned as described in EN 14814 and ISO 9311-3. The pipe used for the high temperature test was GIRPI HTA PN25 PVC-C 63×7.1 and the fittings were GIRPI HMA63. The conditioning time was 20 days at 23+/−2° C. followed by 4 days at 80+/−2° C. The pipes and couplings used were a 63 mm PVC-C pipe with a rating of PN25. The test pressure was 17 Bar and the test temperature was 80° C. The longer the assembled joints withstand the temperature and pressure the better the pretreatment performs.

Application of Pretreatment Compositions to a Substrate:

Thoroughly wet (without soaking) a clean paper towel (e.g., a Scott® Multi-Fold Towel available from Kimberly-Clark Professional) (“wipe”) with the pretreatment composition. Alternatively, a Kimberly-Clark Dual-Texture Meltblown wipe with either the smooth or the scrubby side can be used to apply the pretreatment solution. Evenly apply the pretreatment composition by aggressively wiping the inside surface of a socket at least twice with the pretreatment treated wipe. Using a new treated wipe, vigorously apply the pretreatment on the pipe end for a length equal to the socket depth by aggressively wiping. Allow the pretreatment composition to dry completely before applying the solvent cement following the adhesive manufacturer instructions. In the tests with 2-in. (60.3-mm) PVC Schedule 40 pipe solvent cement was applied following the guidelines of “Standard Practice for Applying Solvent-Cemented Joints with PVC Pipe and Fittings of ASTM D 2855. In the tests with GIRPI HTA PN25 PVC-C 63×7.1 pipes the cement was applied with an acid brush with brush strokes that follow the length of the pipe first to the pipe than to the inside of the socket than to the pipe.

A summary of the prepared pretreatment compositions with the solvent cement along with some pressure test results are provided in the Tables 2 and 3.

TABLE 2
Formulations for the prepared pretreatment compositions and their results.

| Experiment | Control | Control | L2C | L2D | L2E | L2F | L2H | L2I | L2G | L7B | L7C | L7D | L9B | L9C | L9D | L9I | L9J |
|---|---|---|---|---|---|---|---|---|---|---|---|---|---|---|---|---|---|
| # | 1 | 2 | 1 | 2 | 3 | 4 | 5 | 6 | 7 | 12 | 13 | 14 | 16 | 17 | 18 | 23 | 24 |
| Ingredient | | | | | | | | | | | | | | | | | |
| MEK | 100 | 100 | 98.8 | 99.1 | 99.4 | | | | | 98.8 | 99.1 | 99.4 | 83.8 | 84.1 | 84.4 | 69.4 | 69.3 |
| ACE | | | | | | 98.8 | 99.1 | 99.4 | 99.7 | | | | 15 | 15 | 15 | 30 | 30 |
| Dioxolane | | | | | | | | | | | | | | | | | |
| n-Propanol | | | | | | | | | | | | | | | | | |
| Intarome | | | | | | | | | | | | | | | | | 0.1 |
| F176144 | | | | | | | | | | | | | | | | | |
| XL90 | | | | | | | | | | | | | | | | | |
| Lupasol SK | | | | | | | | | | | | | | | | | |
| Lupasol PS | | | | | | | | | | | | | | | | | |
| Lupasol | | | 1.2 | 0.9 | 0.6 | 1.2 | 0.9 | 0.6 | 0.3 | | | | 1.2 | 0.9 | 0.6 | | |
| G20 | | | | | | | | | | | | | | | | | |
| Lupasol | | | | | | | | | | 1.2 | 0.9 | 0.6 | | | | 0.6 | 0.6 |
| WF | | | | | | | | | | | | | | | | | |
| Water | | | | | | | | | | | | | | | | | |
| A-1100 | | | | | | | | | | | | | | | | | |
| Glympo | | | | | | | | | | | | | | | | | |
| VPS SIVO | | | | | | | | | | | | | | | | | |
| 260 | | | | | | | | | | | | | | | | | |
| Total | 100 | | 100 | 100 | 100 | 100 | 100 | 100 | 100 | 100 | 100 | 100 | 100 | 100 | 100 | 100 | 100 |
| Pressure | 56 | | 210 | 461 | 347 | | | | | | | | | | | | |
| Test | | | | | | | | | | | | | | | | | |
| Result (Hr.) | | | | | | | | | | | | | | | | | |
| with solvent | | | | | | | | | | | | | | | | | |
| cement | | | | | | | | | | | | | | | | | |
| described in | | | | | | | | | | | | | | | | | |
| patent; 63 | | | | | | | | | | | | | | | | | |
| mm joint | | | | | | | | | | | | | | | | | |
| 80° C., 247 | | | | | | | | | | | | | | | | | |
| PSI | | | | | | | | | | | | | | | | | |
| brushed | | | | | | | | | | | | | | | | | |
| Pressure | | | 609 | 420 | 3549 | 264 | 284 | 620 | 120 | 273 | 159 | 328 | 436 | 372 | 1330 | | |
| Test | | | | | | | | | | | | | | | | | |
| Result (Hr.) | | | | | | | | | | | | | | | | | |
| with solvent | | | | | | | | | | | | | | | | | |
| cement | | | | | | | | | | | | | | | | | |
| described in | | | | | | | | | | | | | | | | | |
| patent; 63 | | | | | | | | | | | | | | | | | |
| mm joint | | | | | | | | | | | | | | | | | |
| 80° C.; 247 | | | | | | | | | | | | | | | | | |
| PSI wiped | | | | | | | | | | | | | | | | | |
| Pressure | | 522 | | | | | | | | | | | | | | | |
| Test | | | | | | | | | | | | | | | | | |
| Result (Hr.) | | | | | | | | | | | | | | | | | |
| with Weld- | | | | | | | | | | | | | | | | | |
| On 714 | | | | | | | | | | | | | | | | | |
| commercial | | | | | | | | | | | | | | | | | |
| solvent | | | | | | | | | | | | | | | | | |
| cement; 63 | | | | | | | | | | | | | | | | | |
| mm joint | | | | | | | | | | | | | | | | | |
| 80° C.; 247 | | | | | | | | | | | | | | | | | |
| PSI wiped | | | | | | | | | | | | | | | | | |
| pH | | | | | | | | | | | | | | | | | |
| Odor | | | | | | | | | | | | | | | | | More |
| | | | | | | | | | | | | | | | | | pleasant |
| Observation | | | | | | | | | | | | | | | | | |
| of liquid | | | | | | | | | | | | | | | | | |
| after 1 week | | | | | | | | | | | | | | | | | |
| storage | | | | | | | | | | | | | | | | | |
| Observation | | | | | | | | | | | | | Oily | | | | |
| of liquid | | | | | | | | | | | | | Deposit | | | | |
| after 2 | | | | | | | | | | | | | on the | | | | |
| months | | | | | | | | | | | | | bottom | | | | |
| storage | | | | | | | | | | | | | | | | | |

TABLE 3
Additional formulations for the prepared pretreatment compositions and their results.

| Experiment | L10A | L10B | L10C | L10D | L10E | L10F | L11A | L11B | L12A | L12B | L12C | L12D | L12E |
|---|---|---|---|---|---|---|---|---|---|---|---|---|---|
| # | 25 | 26 | 27 | 28 | 29 | 30 | 31 | 32 | 33 | 34 | 35 | 36 | 37 |
| Ingredient | | | | | | | | | | | | | |
| MEK | 99.5 | 99 | 98 | | | | 99.5 | 99 | 84.4 | 69.4 | | | |
| ACE | | | | | | | | | | | | | |
| Dioxolane | | | | | | | | | 15 | 30 | 99.4 | 89.4 | 79.4 |
| n-Propanol | | | | | | | | | | | | 10 | 20 |
| Intarome | | | | | | | | | | | | | |
| F176144 | | | | | | | | | | | | | |
| XL90 | | | | 0.5 | 0.5 | 0.5 | | | | | | | |
| Lupasol SK | 0.5 | 1 | 2 | 0.5 | 1 | 1.5 | | | | | | | |
| Lupasol PS | | | | | | | 0.5 | 1 | | | | | |
| Lupasol G20 | | | | | | | | | 0.6 | 0.6 | 0.6 | 0.6 | 0.6 |
| Lupasol WF | | | | | | | | | | | | | |
| Water | | | | 99 | 98.5 | 98 | | | | | | | |
| A-1100 | | | | | | | | | | | | | |
| Glympo | | | | | | | | | | | | | |
| VPS SIVO | | | | | | | | | | | | | |
| 260 | | | | | | | | | | | | | |
| Total | 100 | 100 | 100 | 100 | 100 | 100 | 100 | 100 | | | | | |
| Pressure | | | | | | | | | | | | | |
| Test | | | | | | | | | | | | | |
| Result (Hr.) | | | | | | | | | | | | | |
| with solvent | | | | | | | | | | | | | |
| cement 63 | | | | | | | | | | | | | |
| mm joint 80° | | | | | | | | | | | | | |
| C. 247 PSI | | | | | | | | | | | | | |
| brushed | | | | | | | | | | | | | |
| Pressure | | | | | | | 152 | 314 | | | | | |
| Test | | | | | | | | | | | | | |
| Result (Hr.) | | | | | | | | | | | | | |
| with solvent | | | | | | | | | | | | | |
| cement 63 | | | | | | | | | | | | | |
| mm joint 80° | | | | | | | | | | | | | |
| C. 247 PSI | | | | | | | | | | | | | |
| wiped | | | | | | | | | | | | | |
| | | | | 7-8 | 7.5-8.5 | 8-9 | | | | | | | |
| Odor | | | | | | | | | | | | | |
| Observation | Does | Does | Does | | | | | | | | Forms | | |
| of liquid | not | not | not | | | | | | | | deposit | | |
| after 1 week | dissolve | dissolve | dissolve | | | | | | | | on the | | |
| storage | | | | | | | | | | | bottom | | |
| Observation | | | | | | | | | | | | | |
| of liquid | | | | | | | | | | | | | |
| after 2 | | | | | | | | | | | | | |
| months | | | | | | | | | | | | | |
| storage | | | | | | | | | | | | | |

The pretreatment compositions did not contain any harmful solvents. The results demonstrate that using the pretreatment composition increased the pressure test resistance of the joints compared to a simple wipe with MEK. In addition, the results show that applying the pretreatment composition with a paper wipe instead of a dauber improves the pressure test results.

The odor of the pretreatment composition can be improved using a masking agent. One example for a masking agent is Intarome F176144 available from Intarome.

The results in Tables 2 and 3 show that some of the Lupasol grades cannot be dissolved in a suitable solvent or do not form stable solutions. Without wishing to be bound to any particular theory, the results show that an improvement in pressure resistance can depend on the concentration of the polyamine in the pretreatment composition.

The results in Tables 2 and 3 show that using a paper wipe results in a longer time to failure than using a brush to apply the pretreatment composition given everything else is unchanged.

### Example 2

The hydrostatic burst strength was tested according to ASTM D2564 6.3.3. A 2-in. (60.3-mm) PVC Schedule 40 pipe meeting the requirements of Specification D 1785 and having the dimensions shown in Table 4 and a PVC Schedule 40 couplings meeting the requirements of Specification D 2466 were used.

TABLE 4
Dimensions of the 2-in. (60.3-mm) PVC Schedule 40 pipe.

| Nominal | Outside | Outside | Wall | Wall | | |
|---|---|---|---|---|---|---|
| size | diameter | diameter | thickness | thickness | Weight | Weight |
| [inches] | [inches] | [mm] | [inches] | [mm] | [lb/ft] | [kg/m] |
| 2 | 2.375 | 60.3 | 0.154 | 3.91 | 3.65 | 5.44 |

Weld-On 721 was used as the solvent cement and applied according to the manufacturer's instructions. The hydrostatic burst strength was determined without any pretreatment composition with a brushed on Weld-On P-68 primer and with a wiped on pretreatment composition according to the invention (Example 23). The results are provided in Table 5.

TABLE 5
Results of quick burst testing

| | Pretreatment/ | | Number | | Test | | Average |
|---|---|---|---|---|---|---|---|
| Pipe Size/Type/ | Application | Solvent | of | Conditioning | Temperature | | burst |
| Material/Fitting | method | Cement | samples | Parameters | in ° C. | Test Method | pressure/PSI |
| 2″ PVC Sch 40 | No chemical | 721 | 5 | 2 hours at | 23 +/− 2° C. | Quick Burst | 614 |
| | cleaner/Dry wipe | | | 23 +/− 2° C. | | | |
| | with clean rag | | | | | | |
| | only | | | | | | |
| | Weld-On P-68 | | 5 | | | | 572 |
| | brushed | | | | | | |
| | Example 23 | | 5 | | | | 715 |
| | wiped with paper | | | | | | |
| | cloth | | | | | | |

The results provided in Table 5 show that Example 23 shows improved results in the quick burst test compared to no pretreatment composition and a pretreatment composition with a standard primer.

A 2-in. (60.3-mm) PVC Schedule 80 pipe meeting the requirements of Specification D 1785 was used in the following pressure test. Weld-On 905 ECO was used as the solvent cement and applied according to the manufacturer's instructions. The hydrostatic burst strength was determined using Example 24 as a pretreatment composition that was applied with a clean paper towel (e.g., a Scott® Multi-Fold Towel available from Kimberly-Clark Professional) or applied using one of the two sides of a Kimberly-Clark Dual-Texture Meltblown wipe (i.e., the smooth side or aggressive side).

TABLE 6
Results of quick burst testing evaluating various cloth types.

| | Pretreatment/ | | | | Test | | Average |
|---|---|---|---|---|---|---|---|
| Pipe Size/Type/ | Application | Solvent | Number of | Conditioning | Temperature | | burst |
| Material/Fitting | method | Cement | samples | Parameters | in ° C. | Test Method | pressure/PSI |
| 2″ PVC Sch 80 | Example 24 | 905 ECO | 10 | 2 hours at | 23 +/− 2° C. | Quick Burst | 712 |
| | Applied with | | | 23 +/− 2° C. | | | |
| | paper towel | | | | | | |
| | Example 24 | | 10 | | | | 757 |
| | Applied with | | | | | | |
| | smooth side of | | | | | | |
| | orange Dual- | | | | | | |
| | Texture wipe | | | | | | |
| | Example 24 | | 10 | | | | 693 |
| | Applied with | | | | | | |
| | aggressive side | | | | | | |
| | of Dual Texture | | | | | | |
| | wipe | | | | | | |

The results provide in Table 6 show that using a soft cloth provides the best quick burst pressure test results.

The foregoing is illustrative of the present invention, and is not to be construed as limiting thereof. The invention is defined by the following claims, with equivalents of the claims to be included therein. All publications, patent applications, patents, patent publications, and other references cited herein are incorporated by reference in their entireties for the teachings relevant to the sentence and/or paragraph in which the reference is presented.

1. A pretreatment composition comprising:
at least one polyamine in an amount in a range of about 0.1% to about 10% by weight of the pretreatment composition; and
a solvent comprising an organic solvent and/or water.

2. The pretreatment composition of claim 1, wherein the at least one polyamine is a polyethyleneimine, polyallylamine, and/or polyvinylamine.

3. The pretreatment composition of claim 1, wherein the at least one polyamine has a molecular weight in a range of about 500 to about 2,500,000 g/mol.

4. The pretreatment composition of claim 1, wherein the pretreatment composition has a viscosity of about 6,000 mPa·s at 23° C. or less or in a range of about 1, 10, 100, or 250 to about 6,000 mPa·s at 23° C. as measured in accordance with ASTM D1084 Method B.

5. (canceled)

6. The pretreatment composition of claim 1, wherein the solvent is present in an amount of at least about 90%, 95%, or 98% by weight of the pretreatment composition.

7. The pretreatment composition of claim 1, wherein the solvent is the organic solvent and the organic solvent is a ketone, an ether, or an alcohol.

8. The pretreatment composition of claim 1, wherein the at least one polyamine is dissolved in the organic solvent.

9. The pretreatment composition of claim 1, wherein the solvent is water and the composition further comprises a surfactant.

10.-11. (canceled)

12. The pretreatment composition of claim 1, wherein the pretreatment composition has a viscosity below the viscosity of water.

13. The pretreatment composition of claim 1, wherein the pretreatment composition is devoid of tetrahydrofuran (THF), N-methyl-2-pyrrolidone (NMP), dimethyl sulfoxide (DMSO), and/or dimethyl formamide (DMF).

14. (canceled)

15. The pretreatment composition of claim 1, wherein the pretreatment composition is compatible with a thermoplastic resin.

16. The pretreatment composition of claim 1, wherein the pretreatment composition at least partially dissolves and/or softens a surface comprising a thermoplastic resin.

17. The pretreatment composition of claim 1, wherein the pretreatment composition consists of the at least one polyamine and the organic solvent.

18. A substrate comprising a thermoplastic resin and a coating on at least a portion of a surface of the thermoplastic resin, wherein the coating comprises the pretreatment composition of claim 1.

19.-20. (canceled)

21. The substrate of claim 1, wherein the thermoplastic resin is a polyvinyl chloride (PVC) resin, chlorinated PVC (CPVC) resin, and/or acrylonitrile-butadiene-styrene (ABS) resin.

22. (canceled)

23. A method comprising:
applying a pretreatment composition according to claim 1 to a first surface of a first thermoplastic resin, wherein the first thermoplastic resin is a polyvinyl chloride (PVC) resin, chlorinated PVC (CPVC) resin, and/or acrylonitrile-butadiene-styrene (ABS) resin.

24. The method of claim 23, wherein applying the pretreatment composition comprises applying the pretreatment composition to the first surface using an applicator.

25.-36. (canceled)

37. A system comprising:
a pretreatment composition according to claim 1; and
a solvent cement comprising a thermoplastic resin and a second solvent.

38. (canceled)

39. An article comprising:
a first substrate and a second substrate, wherein the first and second substrate are joined together using a solvent-welded joint, wherein the solvent-welded joint is formed using the pretreatment composition of claim 1.

40.-42. (canceled)

43. A kit comprising:
a pretreatment composition according to claim 1; and
a solvent cement comprising a thermoplastic resin and a second solvent.

44.-45. (canceled)
